(19) United States
(12) Patent Application Publication
(10) Pub. No.: US 2025/0281935 A1
(43) Pub. Date: Sep. 11, 2025

(54) CONTINUOUS AND SCALABLE FLOW SYSTEM FOR MAGNETIC SEPARATION OF NANOSCALE MAGNETIC PARTICLES

(71) Applicant: Florida State University Research Foundation, Inc., Tallahassee, FL (US)

(72) Inventors: Theo M. Siegrist, Tallahassee, FL (US); Munir Humayun, Tallahassee, FL (US); Petru Andrei, Tallahassee, FL (US)

(21) Appl. No.: 19/073,847

(22) Filed: Mar. 7, 2025

Related U.S. Application Data
(60) Provisional application No. 63/562,744, filed on Mar. 8, 2024.

(51) Int. Cl. B03C 1/033; B03C 1/28

(52) U.S. Cl. CPC B03C 1/0335; B03C 1/286; B03C 2201/18

(57) ABSTRACT

Systems and methods are provided for separating or filtering magnetic nanoscale particles (e.g., such as dysprosium (Dy), iron (Fe), yttrium (Y), cobalt (Co), nickel (Ni), and others) at the industrial scale with minimum energy consumption. A continuous, scalable flow system can be applied equally to the separation of paramagnetic particles and diamagnetic particles. The system can be continuous in the sense that the fluid can be continuously circulated through the separation chamber and, depending on the operating conditions, may not require multiple separation steps. At the same time, the system can be scaled up to industrial applications to separate magnetic particles from a large volume of fluids, for example at a rate of a few cubic meters per hour (m³/hr).

### CROSS-REFERENCE TO RELATED APPLICATION

This application claims the benefit of U.S. Provisional Application Ser. No. 63/562,744, filed Mar. 8, 2024, the disclosure of which is hereby incorporated by reference in its entirety, including all figures, tables, and drawings.

### BACKGROUND

Existing methods for magnetophoretic separation of particles in fluids either use traditional magnetic filtration techniques or systems similar to the ones used in bio and medical applications for magnetic cell separation. The traditional magnetic filtration techniques are only used to separate large magnetic particles (with a diameter over 10 micrometers (μm)) because the magnetic forces decrease abruptly with the diameter of the particle and would make such techniques very inefficient if used on smaller magnetic particles. The magnetic cell separation systems used in bio and medical applications are designed for small-size separation volumes, usually much smaller than a few cubic centimeters. The systems take a long time to perform the separation, and, similar to traditional magnetic filtration techniques, use large magnetic particles on the order of micrometers.

### BRIEF SUMMARY

Embodiments of the subject invention provide novel and advantageous systems and methods for separating or filtering magnetic nanoscale particles (e.g., such as dysprosium (Dy), iron (Fe), yttrium (Y), cobalt (Co), nickel (Ni), and others) at the industrial scale with minimum energy consumption. A continuous, scalable flow system can be applied equally to the separation of paramagnetic particles and diamagnetic particles. The system can be continuous in the sense that the fluid can be continuously circulated through the separation chamber and, depending on the operating conditions, may not require multiple separation steps. At the same time, the system can be scaled up to industrial applications to separate magnetic particles from a large volume of fluids, for example at a rate of a few cubic meters per hour (m³/hr).

In an embodiment, a system for filtering magnetic nanoscale particles from a fluid can comprise: at least one magnetic separation cell configured to have the fluid provided thereto, and each magnetic separation cell of the at least one magnetic separation cell can comprise a plurality of wires conically arranged therein and disposed in a uniform magnetic field. Each wire of the plurality of wires can be a stainless steel wire. The at least one magnetic separation cell can comprise a plurality of magnetic separation cells, and each magnetic separation cell of the plurality of magnetic separation cells can be adjacent to at least one other magnetic separation cell of the plurality of magnetic separation cells. The plurality of magnetic separation cells can be arranged in, for example, an array. Each magnetic separation cell of the at least one magnetic separation cell can further comprise: a first outlet at a bottom portion thereof, wherein the first outlet is disposed below (i.e., directly below) the plurality of wires; and/or a second outlet at a bottom portion thereof, wherein the second outlet is not disposed directly below the plurality of wires. The system can further comprise: a first collection chamber disposed below the at least one magnetic separation cell,; and/or a second collection chamber disposed below the at least one magnetic separation cell and physically separated from the first collection chamber. The first outlet of any or each magnetic separation cell can be connected to the first collection chamber, and/or the second outlet of any or each magnetic separation cell can be connected to the second collection chamber. Each wire of the plurality of wires can have a diameter on the order of micrometers (μm). A value of (B·∇)B of the system can be at least 10⁵ square Tesla per meter (T²/m) during operation. The system can be configured to filter magnetic nanoscale particles having a largest dimension in a range of from 1 nanometer (nm) to 99 nm (e.g., 1 nm to 10 nm). The system can be capable of being scaled up to industrial applications. The uniform magnetic field can be perpendicular to an axis (i.e., a long axis) of at least one of the wires of the plurality of wires. The magnetic nanoscale particles can comprise paramagnetic particles and/or diamagnetic particles.

In another embodiment, a method for filtering magnetic nanoscale particles from a fluid can comprise: providing a system as described in the previous paragraph (including any or all of the features described therein); and providing, to the at least one magnetic separation cell, the fluid comprising the magnetic nanoscale particles to be filtered. The fluid can be continuously provided at a speed in a range of, for example, from 1 micrometers per second (μm/s) to 20 μm/s. The fluid can be provided at a volumetric flow rate in a range of, for example, from 1 m³/hr to 20 m³/hr. The uniform magnetic field can be kept constant while the fluid is provided, or the uniform magnetic field can be interrupted at intervals (e.g., equal time intervals) while the fluid is provided. The magnetic nanoscale particles can comprise paramagnetic particles and/or diamagnetic particles. The magnetic nanoscale particles can comprise at least one of Dy, Fe, Y, Co, and Ni.

### BRIEF DESCRIPTION OF DRAWINGS

FIG. 1(a) shows parallel wires (e.g., stainless-steel wires) placed in a perpendicular magnetic field creating a magnetic field distribution.

FIG. 1(b) shows the magnetic field distribution of stainless-steel wires placed in a perpendicular magnetic field (as shown in FIG. 1(a)), with large values of (B·∇)B.

FIG. 1(c) shows magnetic field distribution of stainless-steel wires placed in a perpendicular magnetic field (as shown in FIG. 1(a)), illustrating that both paramagnetic and diamagnetic particles are being captured by such wires, when a fluid is circulated through the wires.

FIG. 2(a) shows a perspective view of a magnetic separation cell, according to an embodiment of the subject invention.

FIG. 2(b) shows a top view of a network of magnetic separation cells, according to an embodiment of the subject invention.

FIG. 2(c) shows a side view of a network of magnetic separation cells, according to an embodiment of the subject invention. FIG. 1(c) illustrates the distribution of wires (e.g., stainless-steel wires) arranged in conical shapes and the collection channel for magnetic particles.

### DETAILED DESCRIPTION

Embodiments of the subject invention provide novel and advantageous systems and methods for separating or filtering magnetic nanoscale particles (e.g., such as dysprosium (Dy), iron (Fe), yttrium (Y), cobalt (Co), nickel (Ni), and others) at the industrial scale with minimum energy consumption. A continuous, scalable flow system can be applied equally to the separation of paramagnetic particles and diamagnetic particles. The system can be continuous in the sense that the fluid can be continuously circulated through the separation chamber and, depending on the operating conditions, may not require multiple separation steps. At the same time, the system can be scaled up to industrial applications to separate magnetic particles from a large volume of fluids, for example at a rate of a few cubic meters per hour (m³/hr).

In existing methods for the magnetophoretic separation of particles in fluids, the magnetic particles generally need to be large because the existing designs limit the magnitude of (B·∇)B to values between 1 square Tesla per meter (T²/m) and 100 T²/m, which significantly decreases the speed at which the magnetic particles can be separated. In addition, when used in medication applications, the magnetic particles must be large because they need to be removed easily and not interact with living cells.

Existing methods for the separation of magnetic particles are based on traditional magnetic filtration techniques or systems similar to the ones used in bio and medical applications for magnetic cell separation. The creating magnetic field gradients (B·∇)B can be on the order of 100 T²/m and can require the use of various electromagnet or permanent magnet structures.

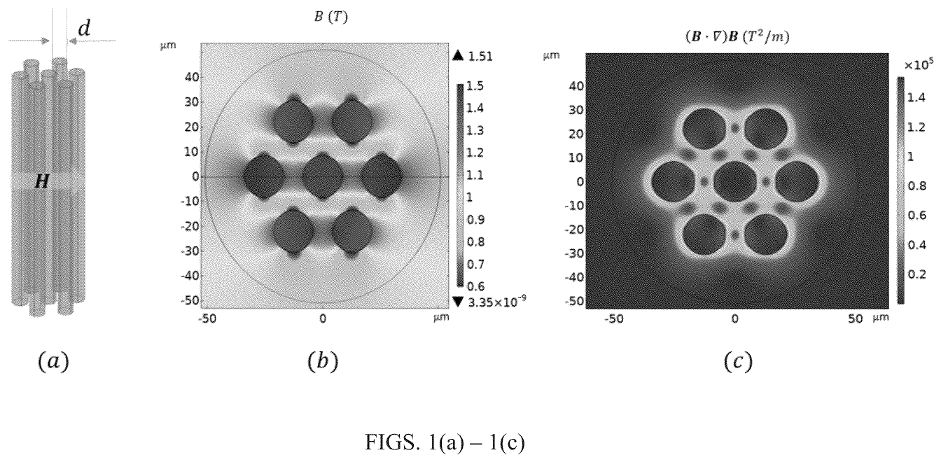

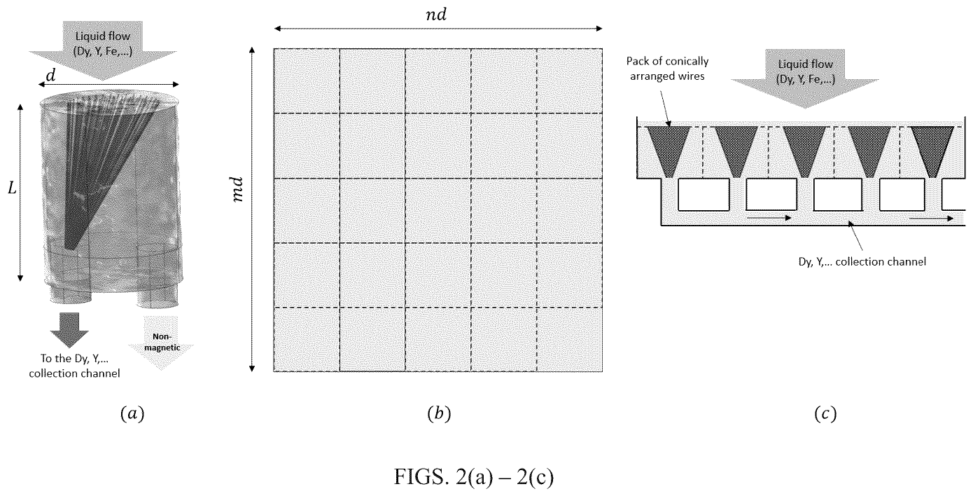

FIG. 1(a) shows parallel wires (e.g., stainless-steel wires) placed in a perpendicular magnetic field creating a magnetic field distribution; FIG. 1(b) shows the magnetic field distribution of stainless-steel wires placed in a perpendicular magnetic field (as shown in FIG. 1(a)), with large values of (B·∇) B; and FIG. 1(c) shows magnetic field distribution of stainless-steel wires placed in a perpendicular magnetic field (as shown in FIG. 1(a)), illustrating that both paramagnetic and diamagnetic particles are being captured by such wires, when a fluid is circulated through the wires. FIG. 2(a) shows a perspective view of a magnetic separation cell, according to an embodiment of the subject invention. FIGS. 2(b) and 2(c) show a top view and a side view, respectively, of a network of magnetic separation cells, according to an embodiment of the subject invention.

FIG. 2(c) illustrates the distribution of wires (e.g., stainless-steel wires) arranged in conical shapes and the collection channel for magnetic particles.

Referring to FIGS. 1(a)-2 (c), in many embodiments, a system for separating magnetic nanoscale particles can comprise a magnetic separation cell or a network of magnetic separation cells (e.g., arranged in an array or other shape), where each magnetic separation cell comprises a collection of wires (e.g., stainless-steel wires) disposed in a perpendicular magnetic field that creates a magnetic field distribution. A fluid containing the magnetic nanoscale particles to be separated can be passed over the magnetic separation cell(s), such as in a direction parallel to an axis of at least one of the wires. Each magnetic separation cell can have at least one outlet at a bottom portion thereof, such as a first outlet below the collection of wires for collecting the magnetic nanoscale particles and a second outlet that is not directly below a bottom of the collection of wires for collecting non-magnetic particles in the fluid. The first outlet can be connected to a first collection chamber and/or the second outlet can be connected to a second collection chamber (the first and second collection chambers, if both present, can be physically separated from each other such that particles filtered thereinto do not mix. The magnetic separation cell(s) can be disposed in a separation chamber, which may or may not include the first and/or second collection chambers, if present.

As seen in FIGS. 2(a) and 2(c), the collection of wires can be disposed in a conical arrangement. Each wire can each have a diameter on the order of micrometers (μm). For example, each wire can each have a diameter in a range of from 1 μm to 950 μm (or any value, about any value, or any subrange contained therewithin), such as from 1 μm to 100 μm. The use of micrometer-size wires (e.g., stainless-steel wires) that are conically arranged in the separation chamber and placed in a uniform magnetic field leads to extremely large values of magnetic field gradients in large volumes. Systems and methods of embodiments of the subject invention allow the separation of very small magnetic particles, such as those having a largest dimension on the order of nanometers (nm) or tens of nanometers. For example, systems and methods of embodiments of the subject invention can allow the separation of magnetic particles having a largest dimension in a range of from 1 nm to 99 nm (or any value, about any value, or any subrange contained therewithin), such as from 1 nm to 50 nm or 1 nm to 10 nm.

The fluid containing the magnetic particles to be separated can be continuously flowed through the separation chamber at speeds of a few micrometers per second (um/s). For example, the speed can be in a range of from 1 μm/s to 20 μm/s (or any value, about any value, or any subrange contained therewithin), such as from 3 μm/s to 10 μm/s. The system can be scaled up to industrial applications to separate magnetic particles from a large volume of fluids, for example at a rate in a range of from 1 m³/hr to 20 m³/hr (or any value, about any value, or any subrange contained therewithin), such as from 3 m³/hr to 10 m³/hr. The arrangement of the wires (e.g., stainless-steel wires) can result in values of (B·∇)B of at least 10⁵ T²/m, which is enough to separate magnetic particles with a diameter on the order of a few nm.

Referring again to FIGS. 1(a)-1(c), the distribution of the magnetic field and the calculated values of (B·∇)B for a distribution of stainless-steel wires placed in a perpendicular magnetic field of 1 Tesla (T) are shown. The large values of (B·∇)B make such wires attract nanoscale particles within seconds, while particles with a largest dimension of less than 1 nm are attracted within hours.

Referring again to FIGS. 2(a)-2(c), by arranging the wires in a conical shape, a magnetic separation cell is formed, in which the magnetic particles are guided to the outlet collection channel, as shown in FIG. 2(a). Multiple such magnetic separation cells can be arranged in a network as shown in FIGS. 2(b) and 2(c). The system can be placed in an external, uniform magnetic field, perpendicular to the wires. This uniform magnetic field can be created by, for example, an electromagnet or permanent magnets such as commercial neodymium (Nd) magnets. Depending on the roughness (and possibly coating) of the wires (e.g., stainless-steel wires) and on the fluid velocity, the external magnetic field can be kept constant or may be interrupted at intervals (e.g., equal time intervals) to allow the magnetic nanoparticles to slide along the length of the wires. The frequency at which the magnetic field is interrupted, if at all, can depends on the speed of the fluid and can be done either electronically in the case of electromagnets or by mechanically removing and bringing the magnets back in the case of permanent magnets.

In many embodiments, design parameters can be selected and altered as desired to separate particles of different types, such as based on their magnetic permeability and size. For example, the length of the collection channel (L), the diameter (or side length) of the magnetic separation unit (d), and/or the velocity of the fluid in the channel can be such design parameters. The estimated separation rate of a system having dimensions of 10 centimeters (cm)×10 cm×5 cm (length×width×height) is more than 1 liter per hour. Because the system is linearly scalable with the number of magnetic separation cell (i.e., doubling the number of magnetic separation cells can double the separation rate), it can be used to separate magnetic particles at high throughput rates.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for filtering magnetic nanoscale particles from a fluid, the system comprising:
at least one magnetic separation cell configured to have the fluid provided thereto,
wherein each magnetic separation cell of the at least one magnetic separation cell comprises a plurality of wires conically arranged therein and disposed in a uniform magnetic field.

2. The system according to claim 1, wherein each wire of the plurality of wires is a stainless steel wire.

3. The system according to claim 1, wherein the at least one magnetic separation cell comprises a plurality of magnetic separation cells,
wherein each magnetic separation cell of the plurality of magnetic separation cells is adjacent to at least one other magnetic separation cell of the plurality of magnetic separation cells, and
wherein the plurality of magnetic separation cells are arranged in an array.

4. The system according to claim 1, wherein each magnetic separation cell of the at least one magnetic separation cell further comprises a first outlet at a bottom portion thereof, wherein the first outlet is disposed below the plurality of wires,
wherein the system further comprises a first collection chamber disposed below the at least one magnetic separation cell, and
wherein the first outlet of each magnetic separation cell is connected to the first collection chamber.

5. The system according to claim 4, wherein each magnetic separation cell of the at least one magnetic separation cell further comprises a second outlet at a bottom portion thereof, wherein the second outlet is not disposed directly below the plurality of wires,
wherein the system further comprises a second collection chamber disposed below the at least one magnetic separation cell and physically separated from the first collection chamber, and
wherein the second outlet of each magnetic separation cell is connected to the second collection chamber.

6. The system according to claim 1, wherein each wire of the plurality of wires has a diameter on the order of micrometers (μm).

7. The system according to claim 1, wherein a value of (B·∇)B of the system is at least 10⁵ square Tesla per meter (T²/m) during operation.

8. The system according to claim 1, wherein the system is configured to filter magnetic nanoscale particles having a largest dimension in a range of from 1 nanometer (nm) to 99 nm.

9. The system according to claim 1, wherein the uniform magnetic field is perpendicular to an axis of at least one of the wires of the plurality of wires.

10. A method for filtering magnetic nanoscale particles from a fluid, the method comprising:
providing a system comprising at least one magnetic separation cell configured to have the fluid provided thereto, wherein each magnetic separation cell of the at least one magnetic separation cell comprises a plurality of wires conically arranged therein and disposed in a uniform magnetic field; and
providing, to the at least one magnetic separation cell, the fluid comprising the magnetic nanoscale particles to be filtered.

11. The method according to claim 10, wherein the fluid is continuously provided at a speed in a range of from 1 micrometers per second (μm/s) to 20 μm/s, and
wherein the fluid is provided at a volumetric flow rate in a range of from 1 cubic meter per hour (m3/hr) to 20 m3/hr.

12. The method according to claim 10, wherein the uniform magnetic field is kept constant while the fluid is provided.

13. The method according to claim 10, wherein the uniform magnetic field is interrupted at equal time intervals while the fluid is provided.

14. The method according to claim 10, wherein the magnetic nanoscale particles comprise at least one of dysprosium (Dy), iron (Fe), yttrium (Y), cobalt (Co), and nickel (Ni).

15. The method according to claim 10, wherein the at least one magnetic separation cell comprises a plurality of magnetic separation cells,
wherein each magnetic separation cell of the plurality of magnetic separation cells is adjacent to at least one other magnetic separation cell of the plurality of magnetic separation cells, and
wherein the plurality of magnetic separation cells are arranged in an array.

16. The method according to claim 10, wherein each magnetic separation cell of the at least one magnetic separation cell further comprises a first outlet at a bottom portion thereof, wherein the first outlet is disposed below the plurality of wires,
wherein each magnetic separation cell of the at least one magnetic separation cell further comprises a second outlet at a bottom portion thereof, wherein the second outlet is not disposed directly below the plurality of wires,
wherein the system further comprises a first collection chamber disposed below the at least one magnetic separation cell, wherein the first outlet of each magnetic separation cell is connected to the first collection chamber, and
wherein the system further comprises a second collection chamber disposed below the at least one magnetic separation cell and physically separated from the first collection chamber, wherein the second outlet of each magnetic separation cell is connected to the second collection chamber.

17. The method according to claim 10, wherein each wire of the plurality of wires has a diameter on the order of micrometers (μm).

18. The method according to claim 10, wherein a value of (B·∇)B of the system is at least 10⁵ square Tesla per meter (T²/m) while the fluid is provided.

19. The method according to claim 10, wherein the magnetic nanoscale particles have a largest dimension in a range of from 1 nanometer (nm) to 99 nm.

20. The method according to claim 10, wherein the uniform magnetic field is perpendicular to an axis of at least one of the wires of the plurality of wires.
